(19) United States
(12) Patent Application Publication
(10) Pub. No.: US 2016/0087849 A1
(43) Pub. Date: Mar. 24, 2016

(54) PLANNING AND RECONFIGURING A MULTILAYER NETWORK

(71) Applicant: Infinera Corporation, Sunnyvale, CA (US)

(72) Inventors: Srivatsan BALASUBRAMANIAN, Bangalore (IN); Steven Joseph Hand, Los Gatos, CA (US); Thirukumaran Velusamy, Bangalore (IN); Jayaram Hanumanthappa, Bangalore (IN)

(21) Appl. No.: 14/586,257

(22) Filed: Dec. 30, 2014

Related U.S. Application Data
(60) Provisional application No. 62/054,407, filed on Sep. 24, 2014.

(51) Int. Cl. H04L 12/24; H04B 10/27

(52) U.S. Cl. CPC H04L 41/12; H04L 41/0813; H04B 10/27

(57) ABSTRACT

A device may receive information that identifies an initial network topology, to be used to reconfigure a network. The initial network topology may describe an optical layer and an internet protocol layer of the network. The internet protocol layer of the network may include an internet protocol node. The device may determine a reconfiguration criterion associated with the initial network topology. The device may determine a reconfiguration technique to be used to reconfigure the network. The device may perform the reconfiguration technique. The device may generate a reconfigured network topology based on performing the reconfiguration technique. The reconfigured network topology may describe a reconfigured internet protocol layer and a reconfigured optical layer. The reconfigured internet protocol layer may be reconfigured based on the optical layer. The reconfigured network topology may be reconfigured based on the initial network topology. The device may provide the reconfigured network topology.

### RELATED APPLICATION

This application claims priority under 35 U.S.C. §119 to U.S. Provisional Patent Application No. 62/054,407, filed on Sep. 24, 2014, the content of which is incorporated by reference herein in its entirety.

### BACKGROUND

A multilayer network may include an internet protocol (IP) network and an optical network. The optical network may transport network traffic between optical devices associated with the multilayer network. One or more IP nodes, associated with the IP network, may route network traffic between IP nodes via the optical network. A multilayer network operator may design the IP network based on the network traffic.

### SUMMARY

According to some possible implementations, a device may include one or more memories and one or more processors connected to the one or more memories. The one or more processors may receive information that identifies an initial network topology, to be used to reconfigure a network. The initial network topology may describe an optical layer and an internet protocol layer of the network. The internet protocol layer of the network may include an internet protocol node. The one or more processors may determine a reconfiguration criterion associated with the initial network topology. The reconfiguration criterion may describe a characteristic of the network, and may be used to reconfigure the network. The one or more processors may determine a reconfiguration technique to be used to reconfigure the network. The reconfiguration technique may include at least one of a local search reconfiguration technique, a simulated annealing reconfiguration technique, or a search diversification reconfiguration technique. The one or more processors may perform the reconfiguration technique. The one or more processors may generate a reconfigured network topology based on performing the reconfiguration technique. The reconfigured network topology may describe a reconfigured internet protocol layer and a reconfigured optical layer. The reconfigured internet protocol layer may be reconfigured based on the optical layer. The reconfigured network topology may be reconfigured based on the initial network topology. The one or more processors may provide the reconfigured network topology.

According to some possible implementations, a computer-readable medium may store instructions that, when executed by one or more processors of a device, cause the one or more processors to receive information that identifies an initial network topology to be used to reconfigure the network. The initial network topology may include information associated with an internet protocol layer and an optical layer of the network. The internet protocol layer may include an internet protocol node. The optical layer may include an optical node. The instructions may cause the one or more processors to determine a reconfiguration criterion associated with the initial network topology. The reconfiguration criterion may describe a characteristic of the network. The instructions may cause the one or more processors to determine a reconfiguration technique to be used to reconfigure the network. The reconfiguration technique may include at least one of a local search reconfiguration technique, a simulated annealing reconfiguration technique, or a search diversification reconfiguration technique. The instructions may cause the one or more processors to perform the reconfiguration technique to obtain a plurality of reconfigured network topologies. The instructions may cause the one or more processors to identify a reconfigured network topology of the plurality of reconfigured network topologies. The reconfigured network topology may describe a reconfigured internet protocol layer and a reconfigured optical layer. The reconfigured internet layer may be reconfigured based on information associated with the optical layer. The instructions may cause the one or more processors to provide the reconfigured network topology.

According to some possible implementations, a method may include receiving, by a device, information that identifies an initial network topology to be used to reconfigure a network. The initial network topology may describe an internet protocol layer and an optical layer of the network. The internet protocol layer may include an internet protocol node. The optical layer may include an optical node. The method may include determining, by the device, an initial network topology cost associated with the network. The initial network topology cost may be a value describing a cost associated with the initial network topology. The method may include determining, by the device, a reconfiguration technique, to be used to reconfigure the network. The reconfiguration technique may include at least one of a local search reconfiguration technique, a simulated annealing reconfiguration technique, or a search diversification reconfiguration technique. The method may include performing, by the device, the reconfiguration technique. The method may include determining, by the device, a reconfigured network topology based on performing the reconfiguration technique. The reconfigured network topology may describe a reconfigured internet protocol layer, and may be determined based on the initial network topology cost. The method may include providing, by the device, the reconfigured network topology.

### BRIEF DESCRIPTION OF THE DRAWINGS

FIGS. 1A-1C are diagrams of an overview of an example implementation described herein;

FIG. 2 is a diagram of an example environment in which systems and/or methods, described herein, may be implemented;

FIG. 3 is a diagram of example components of one or more devices shown in FIG. 2;

FIG. 4 is a flow chart of an example process for reconfiguring a network topology; and

FIG. 5A-5G are diagrams of an example implementation relating to the example process shown in FIG. 4.

### DETAILED DESCRIPTION

The following detailed description of example implementations refers to the accompanying drawings. The same reference numbers in different drawings may identify the same or similar elements.

A multilayer network may include an internet protocol (IP) network and an optical network. One or more optical nodes, associated with the optical network, may transport network traffic between one or more internet protocol (IP) nodes, associated with the IP network. The one or more IP nodes may process and/or route network traffic via the optical nodes. An edge IP node may provide network traffic to and/or receive network traffic from a device that is communicating with the network. A core IP node may provide network traffic to and/or receive network traffic from one or more edge IP nodes via the optical network. Two particular IP nodes may be associated with an IP link (sometimes referred to as an IP adjacency). The IP link may define one or more optical nodes and/or one or more optical links via which to transport network traffic from one of the two particular IP nodes to the other. Network traffic travelling between two particular IP nodes may be routed along one or more intermediate core IP nodes, unless the two particular IP nodes are associated with an IP link. In that case, the network traffic may travel directly from the first particular IP node to the second particular IP node, via the optical layer and based on the IP link. A particular group of IP nodes, and one or more IP links associated with the particular group of IP nodes, may be referred to as an IP network and/or the IP layer. The IP network may be described by an IP network topology. The IP network topology may include information that describes and/or identifies edge IP nodes, core IP nodes, and/or IP links.

The optical node may be a network device, such as a signal amplifier or the like. Two particular optical nodes may be connected by an optical link (e.g., an optical connection, a wired connection, a wireless connection, or a combination of wired and/or wireless connections). A particular group of optical nodes, and one or more optical links associated with the particular group of optical nodes, may be referred to as an optical network and/or an optical layer. The optical network may be described by an optical network topology. The optical network topology may include information that describes one or more optical nodes and/or one or more optical links.

An optical node and/or an optical link may fail (e.g., may experience a hardware failure associated with an optical node, a failure in an optical link, or the like). An IP network component may fail (e.g., an IP node may experience a hardware failure or a software malfunction, a port may fail, a card may fail, or the like). A failure in the optical network (e.g., a failure associated with an optical node and/or an optical link) and/or the IP network (e.g., a failure associated with an IP node) may disrupt network operation (e.g., may interrupt the network traffic, may cause unsatisfactory network service, or the like).

A multilayer network operator may wish to design the IP network to accommodate the network traffic. However, the multilayer network operator may design the IP network without taking into account a combined cost of both the IP layer and the optical layer. By designing the IP network without taking into account the combined cost, the multilayer network operator may reduce the efficiency of the IP network design, thus decreasing network efficiency and increasing cost. Further, the multilayer network operator may not design the IP network to provide protection using optical network features.

Implementations described herein may assist the multilayer network operator in designing the IP network and the optical network using a holistic approach. The multilayer network operator may provide the optical network topology and the IP network topology to a planning device. Additionally, or alternatively, the planning device may determine the IP network topology and/or the optical network topology (e.g., by assuming an initial IP network topology to reconfigure the IP network topology, by receiving an existing IP network topology and/or optical network topology based on an existing IP network and/or optical network, or the like). Based on the optical network topology and the IP network topology, the planning device may iteratively determine a reconfigured network topology, and may reconfigure the multilayer network via a controller device. The reconfigured network topology may be adapted to the optical network topology by design. In this way, the multilayer network operator may ensure that the IP network is designed based on the optical network to facilitate efficient, reliable network operation.

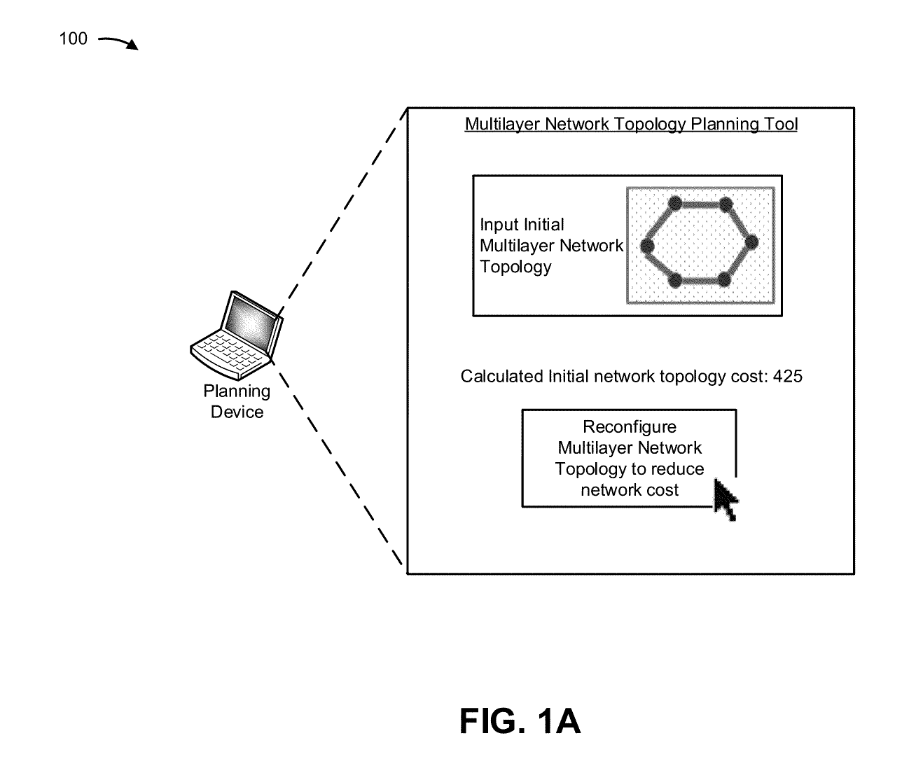

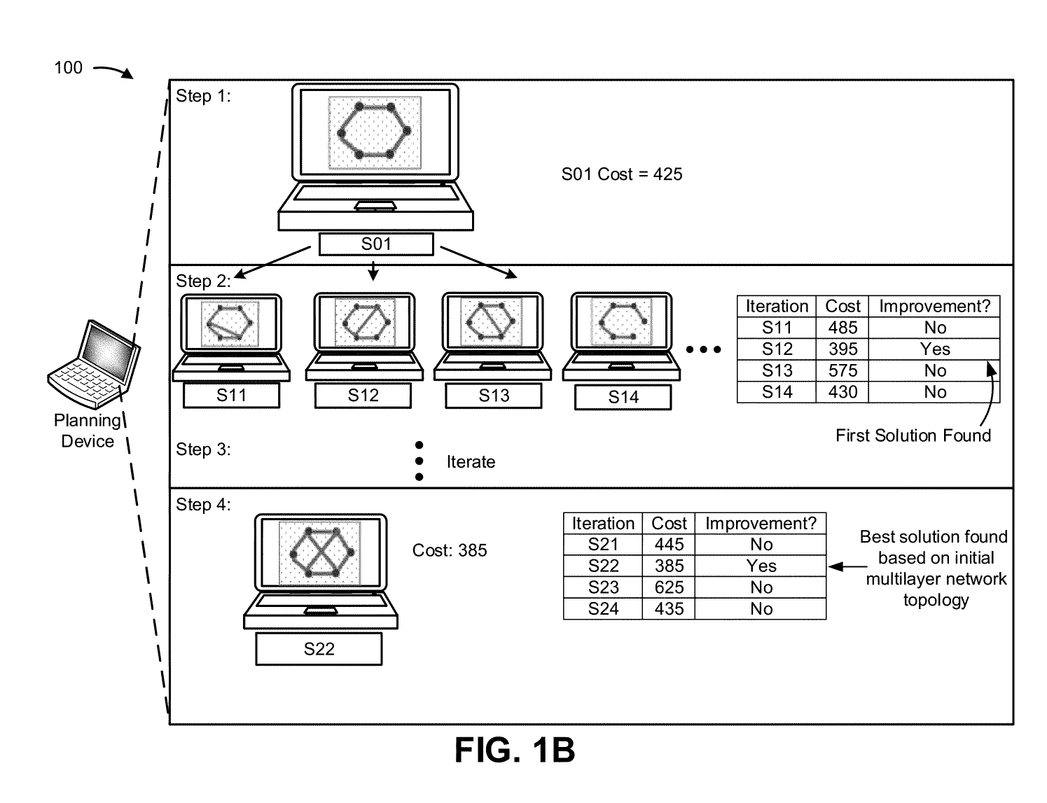

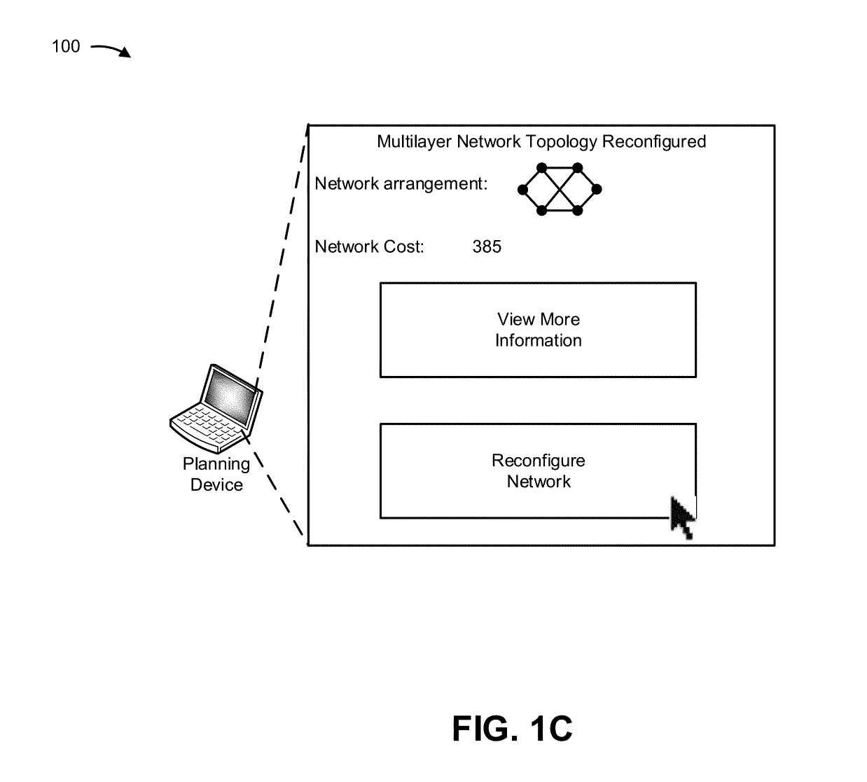

FIGS. 1A-1C are diagrams of an overview of an example implementation 100 described herein. As shown in FIG. 1A, a planning device (e.g., a desktop computer, a laptop computer, etc.) may receive information that identifies an initial multilayer network topology (e.g., via a multilayer network topology planning tool). The information that identifies the initial multilayer network topology may include information related to one or more IP links, one or more IP nodes, one or more optical links, and/or one or more optical nodes. The initial multilayer network topology may describe a multilayer network (e.g., a network including an IP network and an optical network). Using the initial multilayer network topology, and based on a cost of one or more components of the multilayer network, the client device may calculate an initial network topology cost. The initial network topology cost may be a value, based on the initial network topology, that describes a cost of the initial network topology (e.g., the initial network topology cost may include a cost of each IP node, a cost of each optical link, and/or a cost of each optical node, or the like, which the planning device may use to determine the initial multilayer network topology cost). A user may request, via the planning device, that the network topology configuration tool reconfigure the IP network topology, to reduce the initial network topology cost.

As shown in FIG. 1B, the planning device may perform an iterative analysis to configure the network topology (e.g., by performing a local search reconfiguration technique, a search diversification reconfiguration technique, and/or a simulated annealing reconfiguration technique, which are described in more detail elsewhere herein). As shown, the planning device may assign a particular identifier to the initial network topology (here, S01). As further shown, the planning device may iteratively create one or more test network topologies (here, S11, S12, S13, S14, and so on) based on the initial network topology. In some implementations, client device 210 may create the one or more test network topologies using one or more processors operating in parallel. As shown, the planning device may determine a network topology cost associated with each test network topology (here, test network topology S11 is associated with a network topology cost of 485, test network topology S12 is associated with a network topology cost of 395, and so on). As further shown, the planning device may select a reconfigured test network topology, based on the one or more network topology costs associated with the one or more test network topologies. As shown, the planning device may select test network topology S12, associated with a network cost of 395. As further shown, the planning device may iteratively create one or more test network topologies based on test network topology S12, and may select a test network topology based on the one or more network topology costs associated with the one or more iteratively created network topologies. As shown, the planning device may select test topology S22, associated with a network topology cost of 385.

As shown by FIG. 1C, the planning device may display the reconfigured test network topology and the associated network topology cost. As further shown, the planning device may permit the user to view more information related to the reconfigured test network topology. As shown, the planning device may reconfigure the multilayer network based on the reconfigured test network topology. In some implementations, the planning device may cause a controller device to reconfigure the multilayer network. In this way, the planning device may reconfigure the network to lower the cost of the network. The planning device may configure the network topology, based on the existing network topology, to improve the efficiency of the network and decrease the cost of the network.

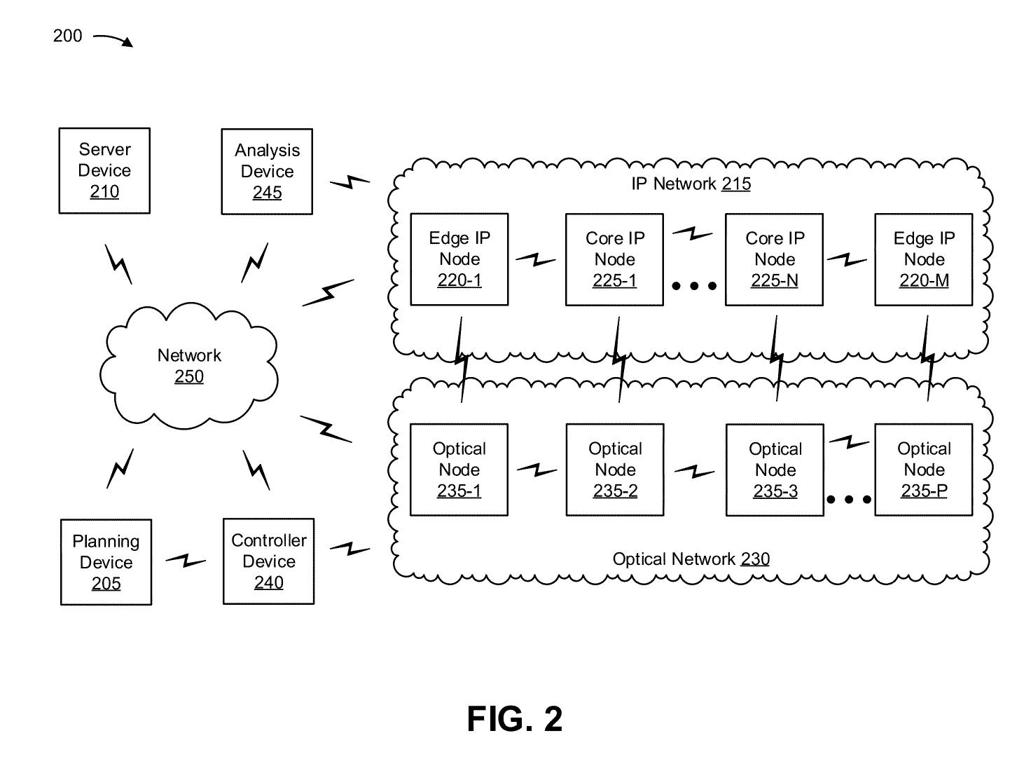

FIG. 2 is a diagram of an example environment 200 in which systems and/or methods, described herein, may be implemented. As shown in FIG. 2, environment 200 may include a planning device 205; a server device 210; an IP network 215; one or more edge IP nodes 220-1 through 220-M (M≧1) (hereinafter referred to collectively as “edge IP nodes 220,” and individually as “edge IP node 220”); one or more core IP nodes 225-1 through 225-N (N≧1) (hereinafter referred to collectively as “core IP nodes 225,” and individually as “core IP node 225”); an optical network 230; one or more optical nodes 235-1 through 235-P (P≧1) (hereinafter referred to collectively as “optical nodes 235,” and individually as “optical node 235”); a controller device 240; an analysis device 245; and a network 250. Devices of environment 200 may interconnect via wired connections, wireless connections, or a combination of wired and wireless connections.

Planning device 205 may include one or more devices capable of receiving, generating, storing, processing, and/or providing information. For example, planning device 205 may include a computing device, such as a server, a desktop computer, a laptop computer, a tablet computer, a handheld computer, a smartphone, or the like. In some implementations, planning device 205 may access and/or execute a network topology reconfiguration tool associated with a different device, such as server device 210. In some implementations, planning device 205 may access a locally stored network topology reconfiguration tool. Planning device 205 may provide, to IP network 215, edge IP node 220, core IP node 225, optical node 235, controller device 240, analysis device 245, and/or another device, network topology configuration information related to configuring IP network 215. In some implementations, planning device 205 may include a multi-layer planning device for planning a network topology associated with IP network 215 and/or optical network 230. In some implementations, planning device 205 may receive a request to reconfigure a network from analysis device 245.

Server device 210 may include one or more devices capable of storing and/or processing information. For example, server device 210 may include a server or a similar device. In some implementations, server device 210 may be included in a cloud computing environment that delivers computing as a service, whereby shared resources, services, etc. may be provided to planning device 205. In some implementations, server device 210 may perform one or more operations related to configuring a network topology. Server device 210 may store network topology configuration information. In some implementations, server device 210 may provide the network topology configuration information to a device, such as edge IP node 220, core IP node 225, optical node 235, configuration device 240, analysis device 245, and/or another device.

IP network 215 may include one or more wired and/or wireless networks. For example, IP network 215 may include a network of one or more edge IP nodes 220, one or more core IP nodes 225, and/or one or more IP links between the one or more edge IP nodes 220 and/or the one or more core IP nodes 225. In some implementations, IP network 215 may route traffic from edge IP node 220 to core IP node 225, between multiple, different edge nodes 220, between multiple, different core nodes 225, and/or from core IP node 225 to edge IP node 220, based on the one or more IP links. In some implementations, IP network 215 may be reconfigured based on a reconfigured network topology.

Edge IP node 220 may include one or more devices (e.g., one or more traffic transfer devices) capable of processing and/or transferring network traffic. For example, edge IP node 220 may include an IP router, an IP gateway, an IP switch, an IP hub, an IP server, a load balancer, or a similar device. In some implementations, edge IP node 220 may receive network traffic from and/or provide network traffic to another edge IP node 220 and/or core IP node 225 based on an IP link. In some implementations, edge IP node 220 may be associated with IP network 215 (e.g., may be included in IP network 215, may be a component of IP network 215, etc.). In some implementations, edge IP node 220 may receive network traffic from and/or provide network traffic to a device not included in IP network 215, such as a device communicating with IP network 215.

Core IP node 225 may include one or more devices (e.g., one or more traffic transfer devices) capable of processing and/or transferring network traffic. For example, core IP node 225 may include an IP router, an IP gateway, an IP switch, an IP hub, an IP server, a load balancer, or a similar device. Core IP node 225 may provide network traffic to and/or receive network traffic from edge IP node 220, another core IP node 225, and/or optical node 235, based on an IP link. In some implementations, core IP node 225 may be associated with IP network 215 (e.g., may be included in IP network 215, may be a component of IP network 215, etc.).

Optical network 230 may include one or more wired and/or wireless networks. For example, optical network 230 may include a fiber optic-based network or a similar type of network. In some implementations, optical network 230 may include one or more optical nodes 235 and one or more optical links between optical nodes 235. In some implementations, optical network 230 may carry network traffic between one or more edge IP nodes 220 and/or one or more core IP nodes 225.

Optical node 235 may include one or more devices (e.g., one or more network traffic transfer devices) capable of processing and/or transferring network traffic. For example, optical node 235 may include an optical router, an optical gateway, an optical switch, an optical hub, an optical add-drop multiplexer, or a similar device. In some implementations, optical node 235 may include one or more devices related to fiber-optic information transmission, such as a fiber-optic transmitter, a fiber-optic receiver, an optical fiber cable, an optical signal amplifier, a wavelength-division multiplexer, a demultiplexer, or the like. In some implementations, two or more optical nodes 235 may communicate via an optical link (e.g., a fiber-optic connection, connecting the two or more optical nodes 235). In some implementations, optical node 235 may be associated with optical network 230 (e.g., may be included in optical network 230, may be a component of optical network 230, etc.).

Controller device 240 may include one or more devices capable of receiving, storing, processing, and/or providing information related to reconfiguring a network. For example, controller device 240 may include a server or a similar device. In some implementations, controller device 240 may provide a network topology to and/or receive a network topology from another device, such as planning device 205, edge IP node 220, core IP node 225, optical node 235, analysis device 245, or another device. In some implementations, controller device 240 may reconfigure IP network 215 and/or optical network 230 based on a network topology. In some implementations, controller device 240 may reconfigure IP network 215 and/or optical network 230 based on a request to reconfigure the network from planning device 205 and/or analysis device 245.

Analysis device 245 may include one or more devices capable of receiving, storing, processing, and/or providing network information related to operating a network. For example, analysis device 245 may include a server or a similar device. In some implementations, analysis device 245 may receive network information from edge IP node 220, core IP node 225, optical node 235, or another device. In some implementations, analysis device 245 may analyze the network information, and/or may provide the network information to planning device 205, controller device 240, or another device. In some implementations, analysis device 245 may provide a request to reconfigure the network to another device, such as planning device 205 and/or controller device 240.

Network 250 may include one or more wired and/or wireless networks. For example, network 250 may include a cellular network, a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

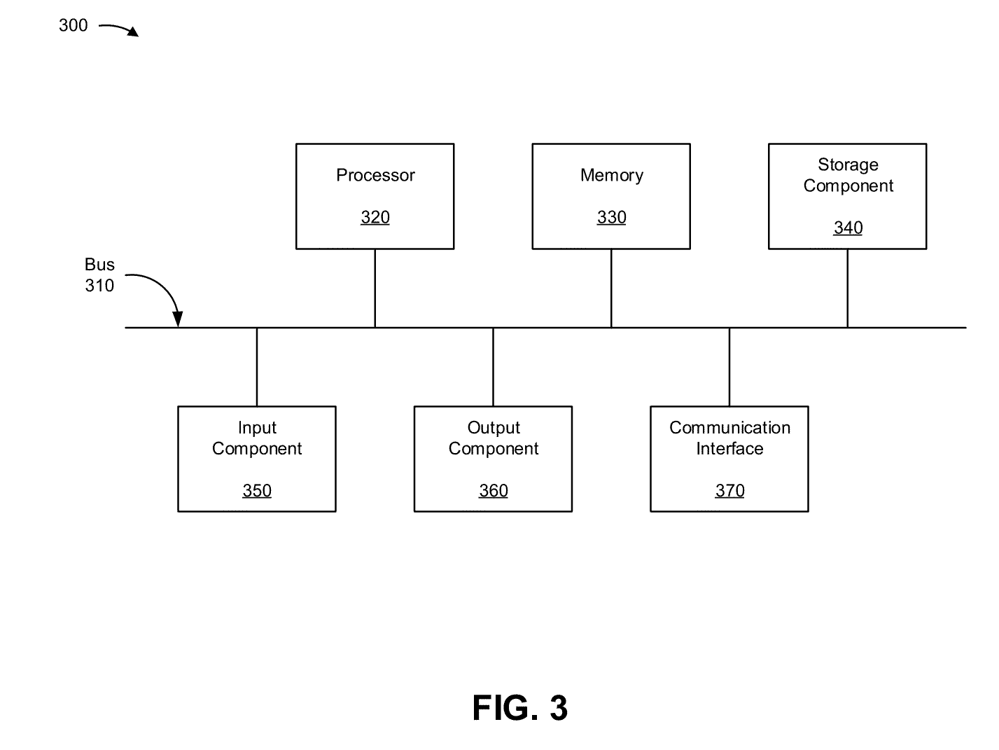

FIG. 3 is a diagram of example components of a device 300. Device 300 may correspond to planning device 205, server device 210, edge IP node 220, core IP node 225, optical node 235, controller device 240, and/or analysis device 245. In some implementations, planning device 205, server device 210, edge IP node 220, core IP node 225, optical node 235 controller device 240, and/or analysis device 245 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 is implemented in hardware, firmware, or a combination of hardware and software. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

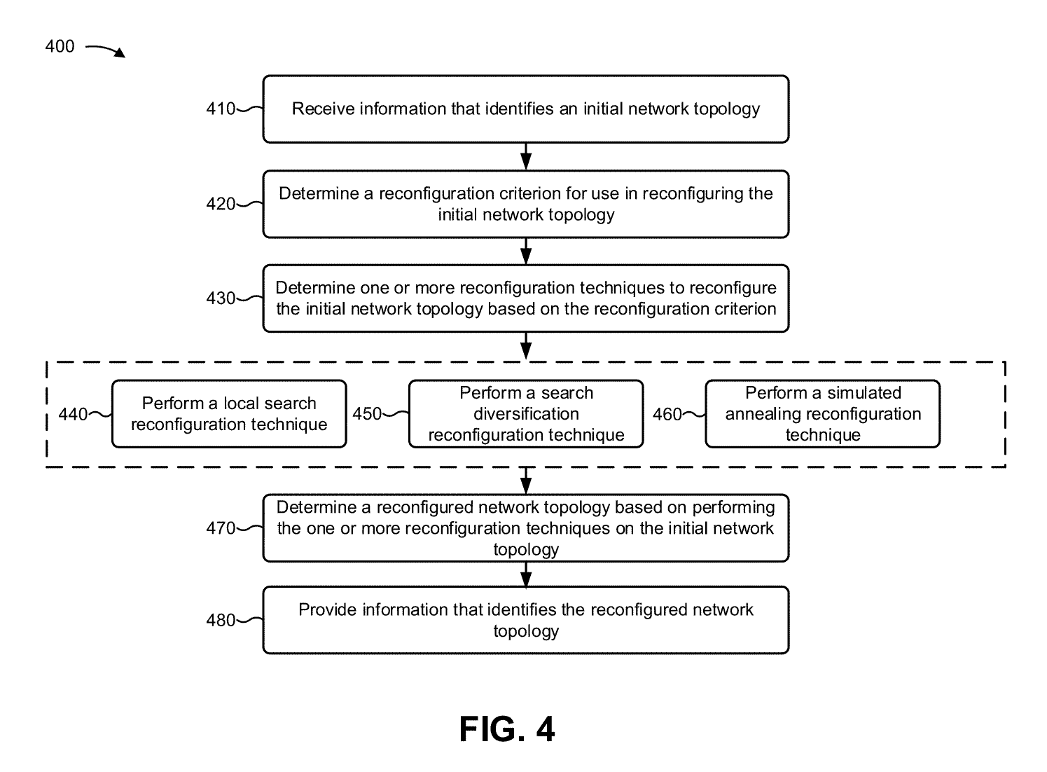

FIG. 4 is a flow chart of an example process 400 for reconfiguring a network topology. In some implementations, one or more process blocks of FIG. 4 may be performed by planning device 205. In some implementations, one or more process blocks of FIG. 4 may be performed by another device or a group of devices separate from or including planning device 205, such as server device 210, controller device 240, analysis device 245, and/or another device.

As shown in FIG. 4, process 400 may include receiving information that identifies an initial network topology (block 410). For example, planning device 205 may receive, via a user input, information that identifies an initial network topology. The information that identifies the initial network topology may include information describing an IP network topology (e.g., information related to IP network 215, edge IP node 220, core IP node 225, and/or one or more IP links between devices associated with IP network 215), information describing an optical network topology (e.g., information related to optical network 230, optical node 235, and/or one or more optical links between devices associated with optical network 230), and/or other information. In some implementations, the initial network topology may be a predetermined network topology (e.g., a full mesh topology that interconnects all IP nodes with IP links, a physical topology that describes an existing IP network 215 and/or optical network 230, a partial mesh topology that interconnects some, but not all, IP nodes with IP links, a ring topology, a topology based on transit flows, a topology generated based on a heuristic algorithm, or the like). In some implementations, planning device 205 may receive the information that identifies the initial network topology from one or more devices, such as edge IP node 220, core IP node 225, optical node 235, controller device 240, analysis device 245, and/or another device.

The information that identifies the initial network topology may include information related to IP network 215. For example, planning device 205 may receive information related to an IP link associated with IP network 215 (e.g., information identifying a source node and a destination node for the IP link; a required capacity of the IP link; a traffic priority identifier, identifying a priority of a network traffic flow associated with the IP link; a service protection attribute, identifying a priority of a network service associated with the IP link; a quantity identifier, identifying a quantity of network traffic flows associated with the IP link; a quantity of IP ports associated with the IP link; or the like). In some implementations, planning device 205 may receive an overprovision indicator (e.g., that indicates a ratio of IP links to each IP node, such as 150%). The overprovision indicator may be used by planning device 205 to ensure that IP network 215 is designed to remain functional in case of a failure in IP network 215 and/or optical network 230.

The information that identifies the initial network topology may include information related to edge IP node 220. For example, planning device 205 may receive information identifying a geographic location of edge IP node 220, a cost associated with edge IP node 220, an IP node identifier that identifies edge IP node 220 as an edge IP node, a priority identifier associated with edge IP node 220 that identifies a priority used by planning device 205 to reconfigure the network topology, one or more nodes with which edge IP node 220 may communicate (e.g., another edge IP node 220, core IP node 225, optical node 235, etc.), or the like.

The information that identifies the initial network topology may include information related to core IP node 225. For example, planning device 205 may receive information identifying a geographic location of core IP node 225, a cost associated with core IP node 225, an IP node identifier that identifies core IP node 225 as a core IP node, a priority identifier associated with core IP node 225 that identifies a priority used by planning device 205 to reconfigure the network topology, one or more nodes that core IP node 225 may provide network traffic to and/or receive network traffic from (e.g., an edge IP node 220, another core IP node 225, an optical node 235, etc.), or the like.

The information that identifies the initial network topology may include information related to optical network 230. For example, planning device 205 may receive information related to one or more optical links, such as a source node identifier and a destination node identifier that identify a source optical node and a destination optical node of the optical link, a shared risk link group identifier (e.g., an identifier, identifying a group of one or more optical links that may be affected by failure associated with optical node 235), information related to one or more costs (e.g., a cost associated with optical node 235, a cost associated with a length of optical fiber, a cost associated with a client-side optical device, a cost associated with a wavelength-division multiplexing line card, or other costs), a data capacity of an optical link (e.g., 100 gigabits per second, 1 terabit per second, or the like), a fiber type (e.g., single mode, multimode, or the like) of an optical link, an optical link length (e.g., five miles, ten miles, or the like), a quantity of optical wavelengths transmitted via an optical link (e.g., one wavelength per fiber, four wavelengths per fiber, eight wavelengths per fiber, or the like).

The information that identifies the initial network topology may include information related to optical node 235. For example, planning device 205 may receive information identifying a geographic location of optical node 235, a cost associated with optical node 235, one or more nodes that optical node 235 may provide network traffic to and/or receive network traffic from (e.g., an edge IP node 220, a core IP node 225, another optical node 235, etc.), or the like.

The information that identifies the initial network topology may identify a failure scenario. For example, planning device 205 may receive information identifying a failure scenario (e.g., one or more conditions related to a failure in IP network 215 and/or in optical network 230). Planning device 205 may receive information identifying an unprotected failure scenario (e.g., a scenario in which a reconfigured IP network 215 is not configured to protect against a failure in IP network 215 and/or in optical network 230), a single optical link failure scenario (e.g., a scenario in which reconfigured IP network 215 is configured to protect against a failure in optical network 230), and/or a single optical link and IP link failure (e.g., a scenario in which reconfigured IP network 215 is configured to protect against a failure in both optical network 230 and IP network 215). Planning device 205 may use the information identifying the failure scenario to generate a reconfigured network topology, as described in more detail elsewhere herein.

The information that identifies the initial network topology may identify a network protection attribute. For example, the network protection attribute may specify a protection type, and may be used by planning device 205 to reconfigure the initial network topology. The protection type may include an unprotected protection type (e.g., planning device 205 may provide no network protection in the reconfigured network topology); an IP network protection type (e.g., planning device 205 may provide protection in IP network 215 against both failure in IP network 215 and failure in optical network 230); an IP network and optical network protection type (e.g., planning device 205 may provide protection in IP network 215 against failure in IP network 215; may provide protection in optical network 230 against failure in optical network 230; or may provide protection based on a combination thereof); or another protection type. The protection against failure provided by planning device 205 is discussed in more detail elsewhere herein.

In some implementations, planning device 205 may store the information that identifies the initial network topology. In some implementations, planning device 205 may provide the information to another device, such as server device 210, controller device 240, analysis device 245, or a different device.

As further shown in FIG. 4, process 400 may include determining a reconfiguration criterion for use in reconfiguring the initial network topology (block 420). For example, planning device 205 may determine a reconfiguration criterion (e.g., a variable associated with one or more values that describe a network). In some implementations, the reconfiguration criterion may include a network topology cost. Planning device 205 may determine the network topology cost based on the initial network topology (e.g., by summing one or more costs, such as a cost associated with IP network 215, a cost associated with optical network 230, a cost associated with a client-side device such as an optical receiver or a demultiplexer card, or other costs). Planning device 205 may receive the reconfiguration criterion as an input. In some implementations, the network topology cost may include a monetary or a non-monetary cost, such as a quantity of resources (e.g., processing resources, memory resources, or the like), a time-based cost, a cost associated with a bandwidth or a capacity of an IP link and/or an optical link, or the like. In some implementations, the reconfiguration criterion may be based on a combination of criteria, such as a network topology cost, a monetary cost, a non-monetary cost, and/or other costs. In some implementations, a reconfiguration criterion based on a combination of criteria may include a relative weight of the criteria (e.g., a network topology cost may be associated with a greater weight than a time-based cost, may be associated with a lesser weight than a cost associated with a bandwidth of an optical link, or the like). The reconfigured network topology may be determined based on the relative weight of the criteria. In this way, a network operator may assign relative weights to a variety of criteria to determine a reconfigured network topology based on the variety of criteria.

As further shown in FIG. 4, process 400 may include determining one or more reconfiguration techniques to reconfigure the initial network topology based on the reconfiguration criterion (block 430). For example, planning device 205 may determine one or more reconfiguration techniques to reconfigure the initial network topology based on the reconfiguration criterion. In some implementations, planning device 205 may receive a reconfiguration technique indicator, indicating one or more reconfiguration techniques to use. In some implementations, the reconfiguration technique may include a local search reconfiguration technique, a search diversification reconfiguration technique, a simulated annealing reconfiguration technique, or the like, which are discussed in more detail elsewhere herein.

In some implementations, one or more devices, such as server device 210, may perform one or more reconfiguration techniques in parallel (e.g., server device 210 may perform a local search reconfiguration technique concurrently with performing a simulated annealing reconfiguration technique). Additionally, or alternatively, the one or more devices may perform operations related to a reconfiguration technique in parallel (e.g., server device 210 may perform multiple, different operations related to the local search reconfiguration technique concurrently). Except as otherwise noted, planning device 205 may perform a single reconfiguration technique, or may perform any combination of multiple reconfiguration techniques. When performing a combination of multiple reconfiguration techniques, planning device 205 may perform the multiple reconfiguration techniques in any order, except as otherwise noted.

In some implementations, the reconfiguration technique may be identified by a user of planning device 205. In some implementations, the reconfiguration technique may be automatically selected. For example, the reconfiguration may be selected by default (e.g., planning device 205 may always perform a first particular reconfiguration technique, followed by a second particular reconfiguration technique, followed by a third particular reconfiguration technique), or may be based on the initial network topology (e.g., when the initial network topology is a full mesh topology, planning device 205 may perform a first particular reconfiguration technique, followed by a second particular reconfiguration technique).

As further shown in FIG. 4, process 400 may include performing a local search reconfiguration technique (block 440). For example, planning device 205 may perform a local search reconfiguration technique to determine a local minimum value of the reconfiguration criterion (e.g., a hill-climbing reconfiguration technique, or the like). In some implementations, planning device 205 may perform the local search reconfiguration technique using one or more local processors. Additionally, or alternatively, another device may perform the local search reconfiguration technique, such as server device 210 or a similar device. In some implementations, a device (e.g., planning device 205, server device 210, or another device) may perform multiple iterations of the local search reconfiguration technique in parallel.

Using the local search reconfiguration technique, planning device 205 may determine a reconfigured network topology by modifying one or more IP links and/or optical links of the initial network topology. Planning device 205 may then select a reconfigured network topology based on the reconfiguration criterion. For example, while performing the local search reconfiguration technique, planning device 205 may generate a first modified network topology by adding and/or removing one or more IP links and/or optical links of the initial network topology. Planning device 205 may determine a value of the reconfiguration criterion of the first modified network topology (e.g., a network topology cost of the first modified network topology). Planning device 205 may selectively accept or reject the first modified network topology based on the value of the reconfiguration criterion (e.g., planning device 205 may accept the first modified network topology if the network topology cost of the first modified network topology is lower than the network topology cost of the initial network topology, and may reject the first modified network topology otherwise).

Planning device 205 may selectively generate a second modified network topology, based on the first modified network topology (e.g., if planning device 205 accepted the first modified network topology, planning device 205 may generate the second modified network topology based on the first modified network topology), or on the initial network topology (e.g., if planning device 205 rejected the first modified network topology, planning device 205 may generate the second modified network topology based on the initial network topology). Planning device 205 may determine a value of the reconfiguration criterion associated with the second modified network topology, and so on. In this way, planning device 205 may determine a reconfigured network topology by determining a local minimum value of the reconfiguration criterion using the local search reconfiguration technique.

In some implementations, planning device 205 may create a first set of modified network topologies, and may determine a value of the reconfiguration criterion associated with each modified network topology of the first set of modified network topologies. Planning device 205 may accept a modified network topology of the first set of modified network topologies based on the value of the reconfiguration criterion. Planning device 205 may selectively create a second set of modified network topologies, based on the first set of modified network topologies (e.g., if planning device 205 accepted one of the first set of modified network topologies, planning device 205 may create the second set of modified network topologies based on the accepted modified network topology). Planning device 205 may continue to iteratively create modified network topologies until planning device 205 determines a local minimum (e.g., a modified network topology associated with a lesser value of the reconfiguration criterion than other modified network topologies). In this way, planning device 205 may determine a modified network topology from a set of modified network topologies.

In some implementations, planning device 205 may not remove a link associated with a network topology. For example, assume an IP node (e.g., edge IP node 220, core IP node 225, or the like) is associated with two or fewer IP links. In that case, planning device 205 may not remove one of the two or fewer IP links (e.g., to prevent edge IP node 220 and/or core IP node 225 from being isolated in the event of a failure associated with one of the two or fewer IP links). In this way, planning device 205 may improve redundancy in the IP layer.

In some implementations, planning device 205 may not remove a link associated with a network topology. For example, assume an optical node 230 is associated with two or fewer optical links In that case, planning device 205 may not remove one of the two or fewer optical links (e.g., to prevent optical node 230 from being isolated in the event of a failure associated with one of the two or fewer optical links). In this way, planning device 205 may improve redundancy in the optical layer.

In some implementations, planning device 205 or another device (e.g., controller device 240) may modify an IP link based on the reconfigured network topology. For example, assume that the initial network topology describes a first IP link that routes network traffic flow via a first optical link. Assume further that the reconfigured network topology describes a second IP link that routes network traffic flow via a second optical link. Planning device 205 may modify the first IP link to match the second IP link, based on the reconfigured network topology. In this way, planning device 205 may improve network performance based on the reconfigured network topology.

As further shown in FIG. 4, process 400 may include performing a search diversification reconfiguration technique (block 450). For example, planning device 205 may perform a search diversification reconfiguration technique. In some implementations, planning device 205 may perform the search diversification reconfiguration technique using one or more local processors. Additionally, or alternatively, another device may perform the search diversification reconfiguration technique, such as server device 210 or a similar device.

Using the search diversification reconfiguration technique, planning device 205 may modify a network topology that has been reconfigured by the local search reconfiguration technique. For example, after performing the local search reconfiguration technique, planning device 205 may add or remove one or more IP links and/or optical links associated with the reconfigured network topology to create a diversified network topology. Planning device 205 may perform the local search reconfiguration technique on the diversified network topology to reconfigure the network topology. By performing the search diversification reconfiguration technique in conjunction with the local search reconfiguration technique, planning device 205 may determine multiple, different local minimum values of the reconfiguration criterion. In this way, planning device 205 may approximate a global minimum value of the reconfiguration criterion.

For example, assume that planning device 205 performs a first iteration of the local search reconfiguration technique, and determines a reconfigured network topology by finding a local minimum value of a reconfiguration criterion. Planning device 205 may subsequently perform the search diversification reconfiguration, using the reconfigured network topology to create a random, diversified network topology. After creating the diversified network topology, planning device 205 may perform a second iteration of the local search reconfiguration technique, and may determine a second reconfigured network topology. By iteratively performing the local search reconfiguration technique and the search diversification reconfiguration technique, planning device 205 may determine a variety of local minimum values of the reconfiguration criterion. Planning device 205 may compare the local minimum values to determine a reconfigured network topology. In this way, planning device 205 may determine the reconfigured network topology by iteratively testing different possible solutions.

As further shown in FIG. 4, process 400 may include performing a simulated annealing reconfiguration technique (block 460). For example, planning device 205 may perform a simulated annealing reconfiguration technique to approximate a global minimum value of the reconfiguration criterion. In some implementations, planning device 205 may perform the simulated annealing reconfiguration technique locally using one or more processors. Additionally, or alternatively, another device may perform the simulated annealing reconfiguration technique, such as server device 210.

Using the simulated annealing reconfiguration technique, planning device 205 may reconfigure the initial network topology. For example, planning device 205 may add or remove one or more IP links and/or optical links to determine a first modified network topology. Planning device 205 may selectively accept or reject the first modified network topology based on a first acceptance threshold. In some implementations, the first acceptance threshold may be defined as a probability of accepting a modified network topology. In that case, planning device 205 may selectively accept the first modified network topology (e.g., may always accept the first modified network topology if the first modified network topology is associated with a network topology cost lower than the initial network topology cost, and may otherwise selectively accept or reject the first modified network topology based on the first acceptance threshold).

If planning device 205 accepted the first modified network topology, planning device 205 may generate a second modified network topology based on the first modified network topology. Planning device 205 may determine a second acceptance threshold based on the first acceptance threshold (e.g., the second acceptance threshold may be less than the first acceptance threshold). Planning device 205 may selectively accept or reject the second modified network topology, based on the first modified network topology, the reconfiguration criterion, and/or the second acceptance threshold. Planning device 205 may continue to iteratively generate modified network topologies and acceptance thresholds.

If planning device 205 rejected the first modified network topology, planning device 205 may generate the second modified network topology based on the initial network topology. Planning device 205 may determine a second acceptance threshold based on the first acceptance threshold. Planning device 205 may selectively accept or reject the second modified network topology, based on the initial network topology, the reconfiguration criterion, and/or the second acceptance threshold. Planning device 205 may continue to iteratively generate modified network topologies and acceptance thresholds. In this way, planning device 205 may approximate a global minimum value of the reconfiguration criterion.

For example, assume that planning device 205 reconfigures an initial network topology using the simulated annealing reconfiguration technique. Assume that the initial network topology is associated with an initial network topology cost of 1000. Assume further that planning device 205 defines a first acceptance threshold as a first probability and a second acceptance threshold as a second probability, the second probability being lower than the first probability. After a first iteration of the simulated annealing reconfiguration technique, planning device 205 may accept one or more output topologies that satisfy the first acceptance threshold (e.g., one or more output topologies that are associated with a network topology cost less than the initial network topology cost of 1000, and/or one or more output topologies associated with output topology costs that are greater than the initial network topology cost, but are accepted based on the first probability associated with the first acceptance threshold). Planning device 205 may perform a second iteration of the simulated annealing reconfiguration technique on the output topologies. Planning device 205 may accept one or more output topologies that satisfy the second acceptance threshold. Planning device 205 may continue to iteratively perform the simulated annealing reconfiguration technique until reaching a threshold (e.g., a threshold number of iterations, a threshold value of the acceptance threshold, a threshold value of the reconfiguration criterion, or the like). In this way, planning device 205 may approximate a global minimum value of the reconfiguration criterion by performing the simulated annealing reconfiguration technique.

As further shown in FIG. 4, process 400 may include determining a reconfigured network topology based on performing the one or more reconfiguration techniques on the initial network topology (block 470). For example, planning device 205 may determine a reconfigured network topology based on performing the one or more reconfiguration techniques on the initial network topology. In some implementations, planning device 205 may determine the reconfigured network topology based on a threshold (e.g., a threshold quantity of iterations of the one or more reconfiguration techniques, a threshold value of the reconfiguration criterion, a threshold time passed while determining the reconfigured network topology, or the like). In some implementations, a different device may determine the reconfigured network topology, such as server device 210.

In some implementations, planning device 205 may determine information related to the reconfigured network topology. For example, planning device 205 may determine an IP link, a capacity of the IP link, one or more nodes associated with the IP link (e.g., one or more edge IP nodes 220, one or more core IP nodes 225, one or more optical nodes 235, or the like), a reconfigured data capacity of the IP link, or the like. Additionally, or alternatively, planning device 205 may determine information related to optical node 235 (e.g., an optical node identifier, identifying the optical node; a number of wavelengths that the optical node may carry; an identifier of a location that can be optically expressed; or the like).

In some implementations, the reconfigured network topology may be configured to provide redundancy in the IP network. For example, assume a network operator wants to ensure that a failure associated with the IP network does not impede network traffic associated with the IP network (e.g., by ensuring that network traffic flow is restored within a time period of less than fifty milliseconds in the event of the failure associated with the IP network). Assume further that one or more IP nodes associated with the IP network are connected by one or more IP links. Assume that the network operator, using planning device 205, specifies a failure scenario of a single optical link and IP link failure scenario, as described elsewhere herein. Based on the failure scenario specified, planning device 205 may design the IP network to associate multiple, different IP links with each IP node. Planning device 205 may design the IP network to route traffic via multiple, different optical links (e.g., to ensure that network traffic flow continues in the event of a failure of an optical link). Planning device 205 may further design the IP network to route a particular network traffic flow via multiple, different IP links. In this way, the network operator may minimize an impedance of network traffic flow in the event of a failure in the IP network, by configuring the network to provide redundancy in the IP network.

In some implementations, the reconfigured network topology may be configured to provide redundancy in the optical network. For example, assume a network operator wants to ensure that a failure in the optical network does not impede network traffic (e.g., by ensuring that network traffic flow is restored within a time period of fifty milliseconds in the event of the failure in the optical network). Assume further that the optical network includes one or more optical nodes that are connected by one or more optical links. Assume that the network operator, using planning device 205, specifies a failure scenario of a single optical link failure scenario, as described in connection with FIG. 2 elsewhere herein. Assume that a network traffic flow is transported via the one or more optical nodes and/or the one or more optical links. Assume that the network traffic flow is routed by one or more devices associated with the IP network. In that case, and based on the failure scenario specified, planning device 205 may design the IP network to route the network traffic flow via two different optical nodes that are not in the same geographical location. In this way, the network operator may ensure that a failure of an optical node and/or an optical link does not interrupt the network traffic flow, by configuring the network to provide redundancy in the optical network.

Implementations described herein may describe a network configured to provide redundancy in IP network 215, in optical network 230, and/or in both IP network 215 and optical network 230. In other words, the network may be configured to provide redundancy in both IP network 215 and optical network 230.

In some implementations, IP network 215 and/or optical network 230 may be configured based on a hold-off time (e.g., a time period after a failure in optical network 230 during which IP network 215 may not take action to protect network traffic). For example, assume that IP network 215 is configured with a hold-off time of 50 milliseconds. Assume further that optical network 230 is configured to restore network traffic flow in the event of a single optical link failure (e.g., by re-routing network traffic based on the single optical link failure). In some implementations, optical network protection may be achieved by overprovisioning resources that are dedicated for protection. In some implementations, optical network protection may be achieved by sharing resources across different failure scenarios. Further, in some implementations, the failure recovery in optical network 230 may be achieved within 50 milliseconds. Assume that a single optical link of optical network 230 fails. Based on the single optical link failure, optical network 230 may restore network traffic flow. If optical network 230 restores network traffic flow within 50 milliseconds of the single optical link failure, IP network 215 may take no action. In this way, optical network 230 may be designed to restore network traffic flow in the case of a failure in optical network 230. IP network 215 may be configured to take no action for a set time, to allow optical network 230 adequate time to attempt to restore network traffic flow. By taking no action based on the hold-off time, and by restoring network traffic flow after the hold-off time only if required, using excess residual network capacity, IP network 215 may improve network efficiency in the case of a failure in IP network 215 or optical network 230.

In some implementations, the reconfigured network topology may be configured to protect network traffic flow in IP network 215 and in optical network 230. For example, assume that a network operator, using planning device 205, requests a reconfigured network topology that is configured to protect network traffic flow in IP network 215 and in optical network 230. Based on the request, planning device 205 may configure IP network 215 to protect network traffic flow by providing redundancy (e.g., by providing redundant IP links, by providing additional bandwidth to IP nodes, by routing traffic via multiple, different optical links, or the like). Planning device 205 may further reconfigure IP network 215 to protect network traffic flow via optical network 230 by routing network traffic based on a failure in optical network 230. For example, edge IP node 220 and/or core IP node 225 may detect a failure of an IP link that routes network traffic via a particular, failed optical link of optical network 230. Based on detecting the failure of the IP link, edge IP node 220 and/or core IP node 225 may route network traffic via one or more different optical links In some implementations, edge IP node 220 and/or core IP node 225 may route the network traffic via one or more different optical links after a set time (e.g., if IP network 215 is configured with a hold-off time). In this way, the network operator may configure the network to protect network traffic flow in IP network 215 and optical network 230.

In some implementations, the reconfigured network topology may be configured based on a link priority indicator associated with one or more IP links and/or optical links For example, assume that a network operator wants to ensure that a particular network link is prioritized during the network configuration process (e.g., so that the particular network link is provided with additional bandwidth, or the like). The network operator may specify, using planning device 205, a link priority indicator, associated with the particular network link. Planning device 205 may configure the network to provide priority to the particular link, based on the link priority indicator. In this way, the network operator may ensure that the network is configured to provide priority to the particular network link.

In some implementations, the reconfigured network topology may be configured based on a traffic priority indicator associated with a network traffic flow. For example, assume that a network operator wants to ensure that a particular network traffic flow is prioritized (e.g., that the particular network traffic flow receives adequate bandwidth in the optical network, that the particular network traffic flow is routed before a non-prioritized network traffic flow, that the particular network traffic flow is prioritized in the event of a failure of the network, or the like). The network operator may specify, using planning device 205, a traffic priority indicator, associated with the particular network traffic flow. Planning device 205 may configure the network to provide priority to the particular network traffic flow, based on the traffic priority indicator.

In some implementations, the reconfigured network topology may be configured based on a service protection attribute associated with a network service. For example, assume that a network operator wants to ensure that a particular network service is protected (e.g., that the particular network service receives adequate bandwidth in the optical network, that the particular network service is routed before a non-prioritized network traffic flow, that the particular network service is protected in the event of a failure of the network, or the like). The network operator may specify, using planning device 205, a service protection attribute associated with the particular network service. Planning device 205 may configure the network to provide protection to the particular network service based on the traffic priority indicator.

In some implementations, one or more devices in the IP network may provide priority to the particular network traffic flow. Additionally, or alternatively, a device in the optical network, such as optical node 235, may be configured to identify the traffic priority indicator. In that case, the device in the optical network may provide priority to the particular network traffic flow (e.g., may provide bandwidth to the particular network traffic flow rather than to another network traffic flow, may provide protection or redundancy to the particular network traffic flow rather than to another network traffic flow, or the like). In this way, the network operator may ensure that the network is configured to provide priority to the particular network traffic flow.

In some implementations, the reconfigured network topology may be configured to connect edge IP node 220 with two different core IP nodes 225 based on a connection criterion (e.g., a criterion input by a user). For example, assume that planning device 205 wants to connect edge IP node 220 with two different core IP nodes 225 based on a shortest IP link connection criterion (e.g., edge IP node 220 will be connected with two core IP nodes 225, based on a length associated with an IP link between edge IP node 220 and each of the two core IP nodes 225). In that case, planning device 205 may generate a dummy node in IP network 215 and/or optical network 230 (e.g., a node used for an operation related to configuring the network topology). Planning device 205 may iteratively connect edge IP node 220 to the dummy node, via multiple, different core IP nodes 225. Planning device 205 may perform one or more operations to determine two particular core IP nodes 225 that connect edge IP node 220 to the dummy node via a shortest-length IP link. Planning device 205 may configure the network to connect edge IP node 220 to the two particular core IP nodes 225. In this way, planning device 205 may improve the efficiency of the IP network, by reducing (e g , minimizing) a length associated with one or more IP links. Planning device 205 may further improve reliability of the IP network by creating redundant IP links from edge IP node 220 to multiple, different core IP nodes 225.

In some implementations, planning device 205 may determine a second reconfigured network topology after determining a first reconfigured network topology. For example, assume that, after determining a first reconfigured network topology, an aspect of the network topology changes (e.g., a bandwidth of a network link changes, a network traffic flow changes, or the like). Based on the change of the aspect of the network topology, planning device 205 may determine a second reconfigured network topology, to reduce a network topology cost associated with the first reconfigured network topology.

In some implementations, planning device 205 may determine the second reconfigured network topology based on a user interaction (e.g., based on a user request that planning device 205 determine the second reconfigured network topology). In this way, a user (e.g., a network operator) may repeatedly cause planning device 205 to reconfigure a network topology to improve network performance.

Additionally, or alternatively, planning device 205 may determine the second reconfigured network topology based on a request from analysis device 245. For example, analysis device 245 may request that planning device 205 reconfigure the network topology, based on a change in the network topology, such as a change in network traffic. In that case, planning device 205 may determine the second reconfigured network topology, and may provide the second reconfigured network topology to another device, such as controller device 240. Controller device 240 may reconfigure the network based on the second reconfigured network topology. In this way, analysis device 245 may cause planning device 205 to repeatedly reconfigure a network topology to improve network performance.

In some implementations, planning device 205 may determine a reconfigured network topology including a reconfigured optical topology. For example, assume that network traffic is routed via a first optical link based on a first IP link from a first IP node to a second IP node. Assume further that the network traffic from the first IP node to the second IP node ceases. Assume that a device (e.g., analysis device 245) detects network traffic flowing from the first IP node to a third IP node. Based on the network traffic flowing from the first IP node to the third IP node, the device may cause planning device 205 to reconfigure IP network 215 and optical network 230. In this case, planning device 205 may create a second IP link between the first IP node and the third IP node. Planning device 205 may further remove the first optical link, and may create a second optical link based on the second IP link. In this way, planning device 205 may determine a reconfigured network topology including a reconfigured optical topology. In some implementations, planning device 205 may reconfigure IP network 215 and/or optical network 230 based on the reconfigured network topology, or may cause controller device 240 to reconfigure IP network 215 and/or optical network 230 based on the reconfigured network topology.

As further shown in FIG. 4, process 400 may include providing information that identifies the reconfigured network topology (block 480). For example, planning device 205 may provide information that identifies the reconfigured network topology. In some implementations, planning device 205 may provide the information that identifies the reconfigured network topology via a user interface. Additionally, or alternatively, planning device 205 may provide the information that identifies the reconfigured network topology to a device, such as edge IP node 220, core IP node 225, optical node 235, controller device 240, analysis device 245, and/or another device.

In some implementations, planning device 205 may provide the information that identifies the reconfigured network topology to controller device 240. In that case, controller device 240, edge IP node 220, and/or core IP node 225 may reconfigure IP network 215 based on the reconfigured network topology. For example, assume that planning device 205 provides, to controller device 240, a reconfigured network topology that is different than a network topology associated with edge IP node 220 and core IP node 225. Controller device 240, edge IP node 220 and/or core IP node 225 may reconfigure, add, and/or remove an IP link and/or an optical link based on the reconfigured network topology (e.g., an IP link, edge IP node 220, core IP node 225, or the like).

In some implementations, edge IP node 220 and/or core IP node 225 may store an IP link (e.g., information that causes edge IP node 220 and/or core IP node 225 to route network traffic via one or more optical nodes 235 and/or one or more optical links). Based on the reconfigured network topology, edge IP node 220 and/or core IP node 225 may reconfigure the IP link (e.g., by changing the IP link to cause edge IP node 220 and/or core IP node 225 to route network traffic via a different optical node 235 and/or a different optical link). In this way, controller device 240 may cause edge IP node 220 and/or core IP node 225 to reconfigure IP network 215, based on the reconfigured network topology.

Although this detailed description describes optical network 230 as an optical network, in some implementations, optical network 230 may include another type of network.

In this way, the network operator may design the IP network based on the optical network topology. Based on the optical network topology and the IP network topology, planning device 205 may iteratively determine a reconfigured IP network topology. The reconfigured IP network topology may be adapted to the optical network topology by design. In this way, the network operator may ensure that the IP network is designed based on the optical network to facilitate efficient, reliable network operation.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

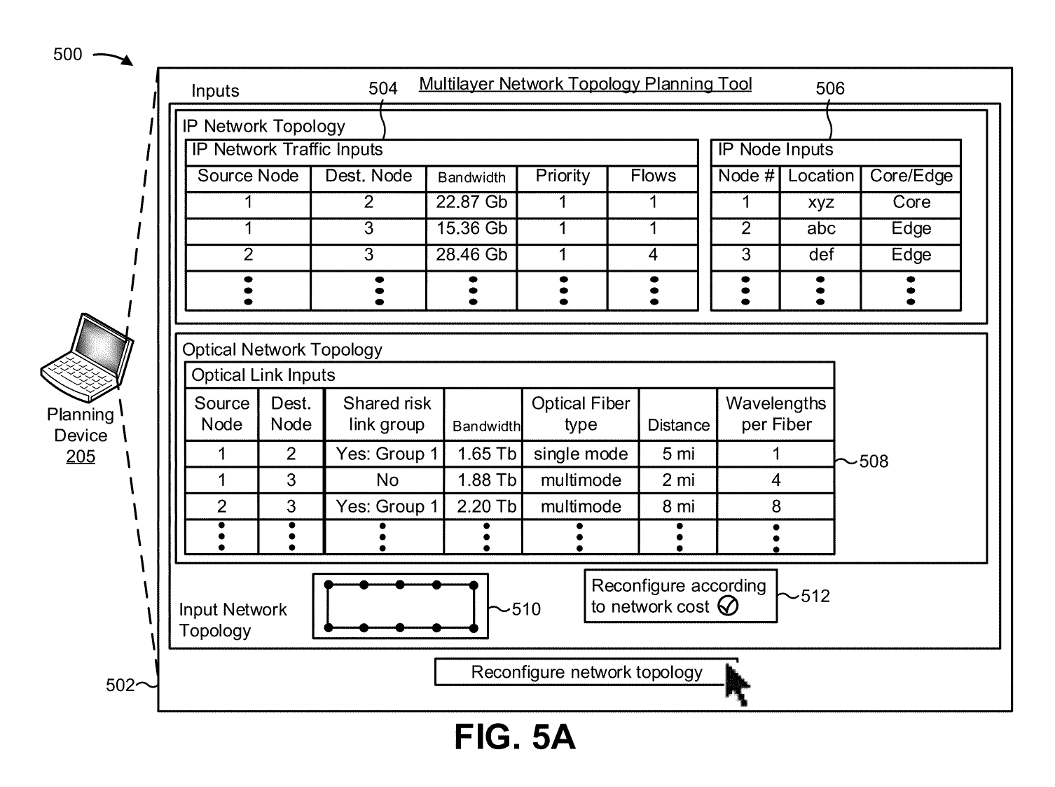

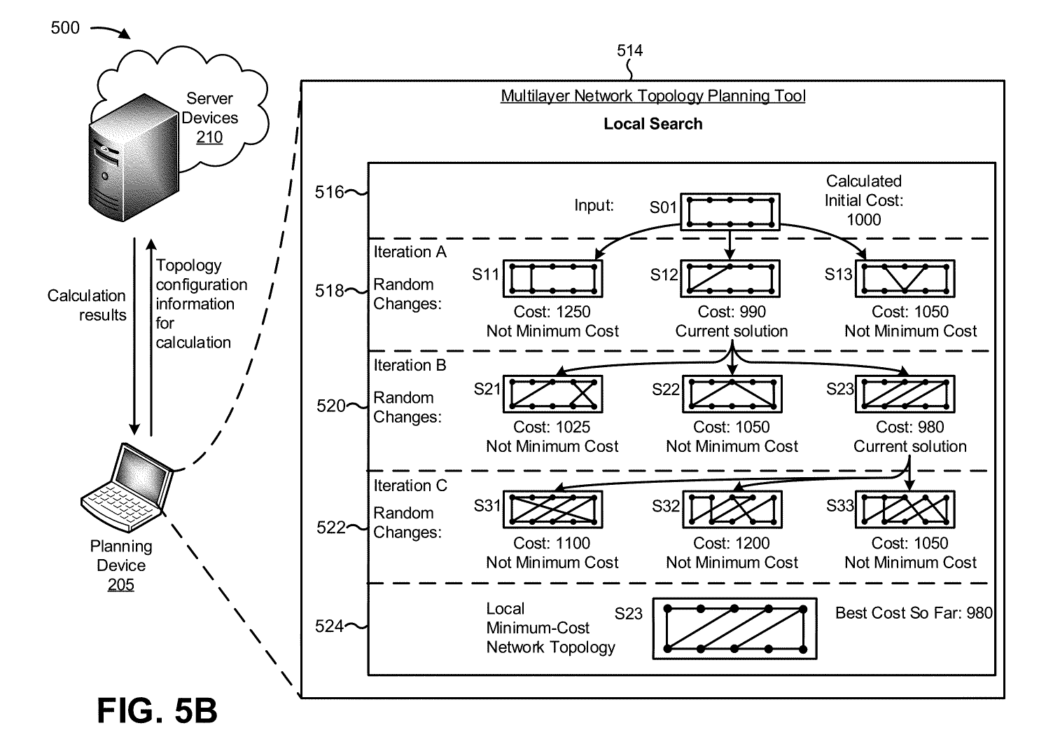

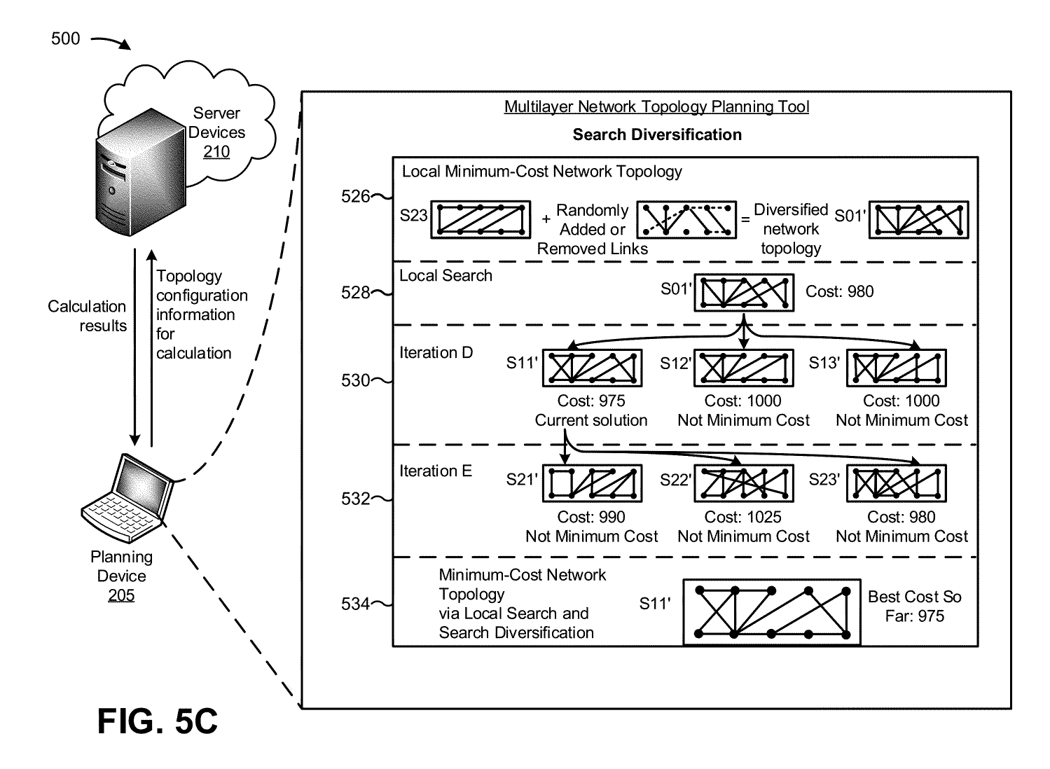

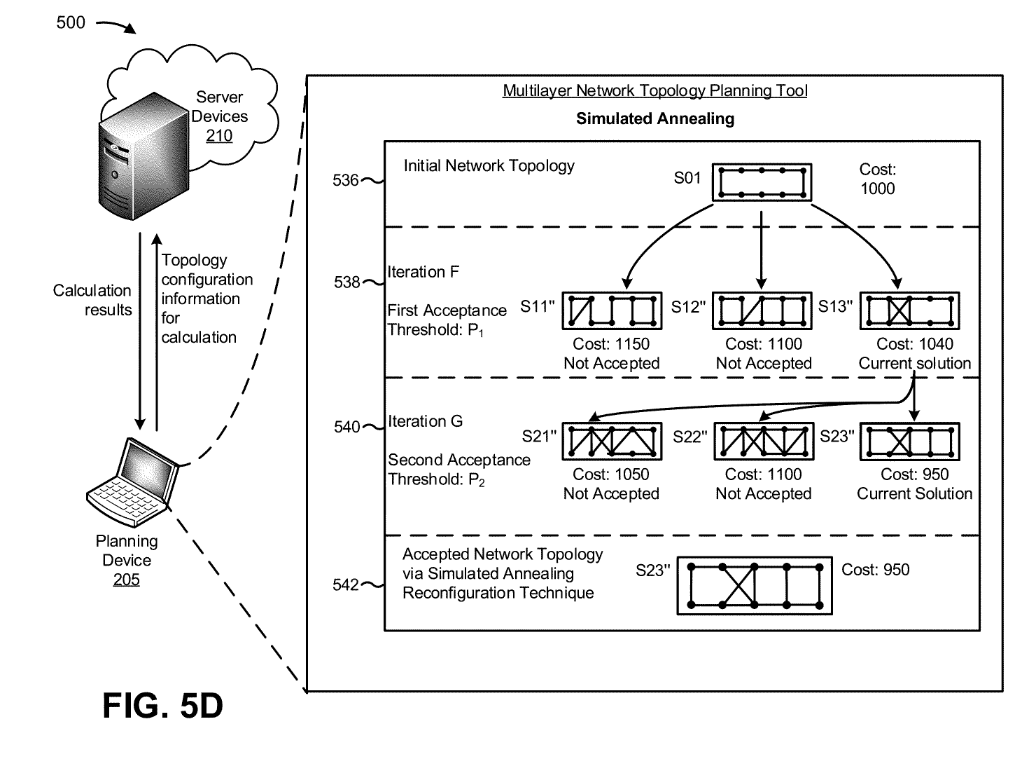

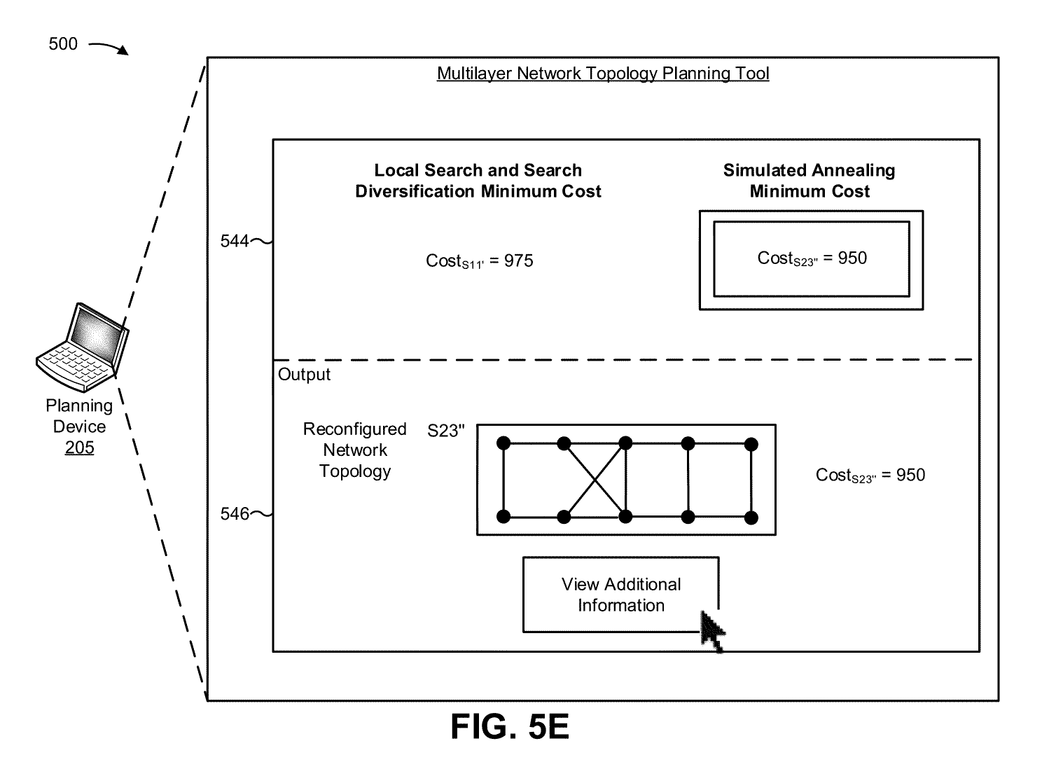

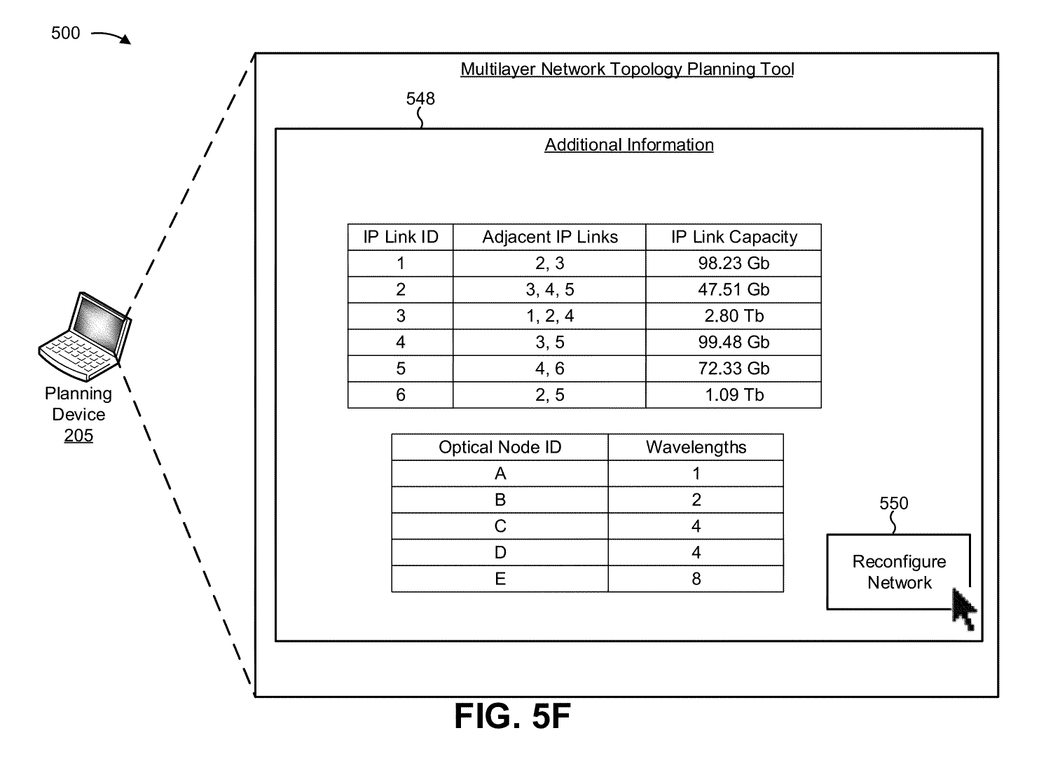

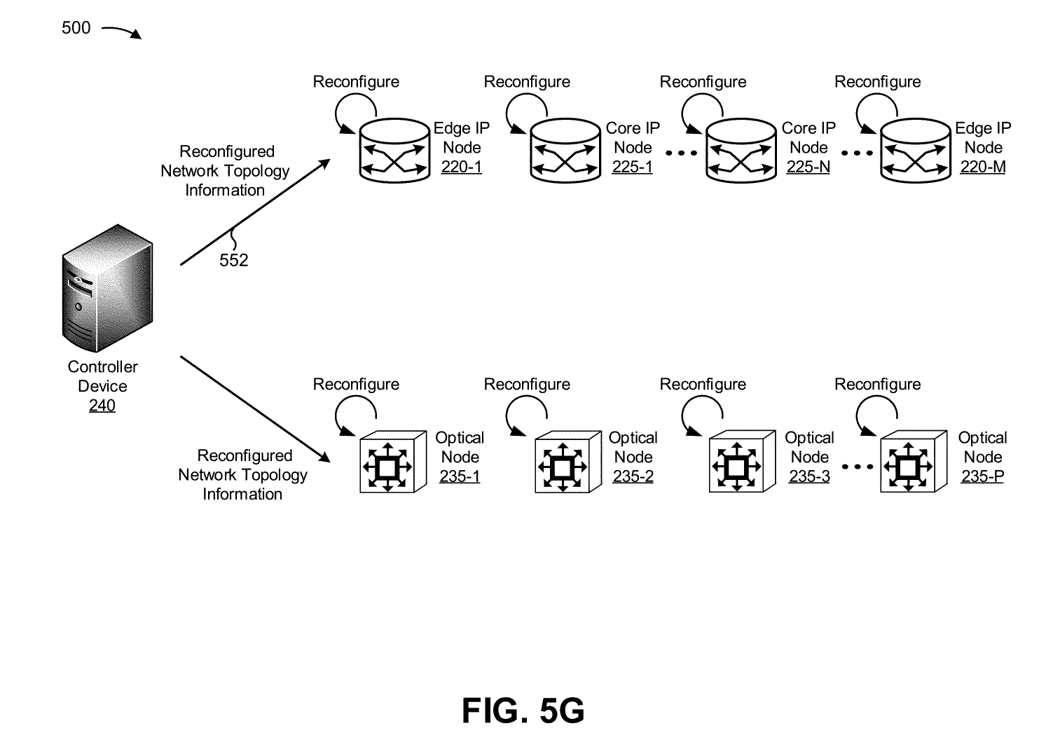

FIGS. 5A-5G are diagrams of an example implementation 500 relating to example process 400 shown in FIG. 4. FIGS. 5A-5G show an example of reconfiguring a network topology. For the purpose of FIGS. 5A-5G, assume that planning device 205 is configured to perform a first local search reconfiguration technique, followed by a search diversification reconfiguration technique, followed by a second local search reconfiguration technique, followed by a simulated annealing reconfiguration technique.

For the purpose of FIG. 5A, assume that a user, via planning device 205, inputs the information shown. As shown in FIG. 5A, and by reference number 502, planning device 205 may receive information describing a network topology, including an IP network topology and an optical network topology. For example, planning device 205 may receive the information describing the network topology based on an input from the user, from controller device 240 (e.g., an IP controller device, an optical controller device, or the like), from analysis device 245, and/or from another device.

As shown by reference number 504, planning device 205 may receive information that describes network traffic associated with IP network 215. Here, as shown, planning device 205 receives information identifying a source IP node and a destination IP node of one or more IP links, a data capacity of the one or more IP links, a link priority identifier associated with the one or more IP links, and a quantity of network traffic flows associated with the one or more IP links.

As shown by reference number 506, planning device 205 may receive information that describes one or more IP nodes (here, the information describes IP nodes 1, 2, 3, and so on). Here, as shown, planning device 205 receives a node identifier that identifies the one or more IP nodes, a location identifier that identifies a geographic location of the one or more IP nodes, and an IP node identifier that identifier that identifies the one or more IP nodes as an edge IP node or a core IP node.

As shown by reference number 508, planning device 205 may receive information that describes the optical network topology. Here, as further shown, planning device 205 may receive information that describes one or more optical links As shown, planning device 205 may receive information identifying a source node and a destination node of the one or more optical links, a shared risk link group identifier associated with the one or more optical links, a data capacity associated with the one or more optical links, an optical fiber type identifier that identifies an optical fiber type associated with the one or more optical links, a distance identifier that identifies a length of the one or more optical links, and a quantity of wavelengths per fiber, associated with the one or more optical links.

As shown by reference number 510, the input network topology may be represented by a graphic. Assume that the graphic represents both the IP network topology and the optical network topology. As shown by reference number 512, planning device 205 may choose to reconfigure the network based on a reconfiguration criterion (here, the reconfiguration criterion is a network topology cost associated with the network). As further shown, planning device 205 may determine an initial network topology cost associated with the initial IP network topology and the initial optical network topology. As shown, the user may instruct planning device 205 to perform the network topology reconfiguration.

As shown in FIG. 5B, and by reference number 514, planning device 205 may perform a local search reconfiguration technique on the initial network topology. As shown by reference number 516, planning device 205 may assign a topology identifier to the initial network topology (here, the topology identifier is S01). As shown by reference number 518, planning device 205 may make one or more random changes to the initial network topology to generate an iteration output topologies, and may associate one or more topology identifiers with the output topologies (here, the iteration is shown as iteration A, and the output topologies of iteration A are associated with the topology identifiers of S11, S12, and S13). In some implementations, planning device 205 may make a non-random change (e.g., may systematically add or remove a single link, or the like). As shown, planning device 205 may determine a cost associated with each output topology, and may select an output topology as a current solution based on the network topology cost (here, planning device 205 selects output topology S12, associated with a network topology cost of 990).

As shown by reference number 520, planning device 205 may generate an iteration of output topologies using the local search reconfiguration technique and based on output topology S12 (here, the iteration is shown as iteration B). Planning device 205 may determine a network topology cost associated with each output topology. As shown, planning device 205 may select an output topology as a current solution if one of the output topologies of iteration B is associated with a lower network topology cost than output topology S12. Here, output topology S23 is associated with a network topology cost of 980. Planning device 205 may determine that the network topology cost of 980 is a lower network topology cost than the network topology cost of 990 associated with output topology S12, and is a lower network topology cost than the network topology costs associated with the other output topology costs in iteration B. Planning device 205 may select output topology S23 as a current solution based on the lower network topology cost.

As shown by reference number 522, planning device 205 may generate an iteration of additional output topologies (here, the iteration is shown as iteration C) using the local search reconfiguration technique and based on output topology S23. As further shown, planning device 205 may determine a network topology cost associated with each output topology, and may select an output topology as a current solution based on the network topology cost. Here, no output topology in iteration C is associated with a lower network topology cost than output topology S23, so planning device 205 selects none of the output topologies of iteration C. As shown by reference number 524, planning device 205 may determine that output topology S23 is a local minimum-cost topology, based on iteration no output topology associated with a lower network topology cost than output topology S23.

As shown in FIG. 5C, and by reference number 526, planning device 205 may use a search diversification reconfiguration technique to create a diversified network topology. As further shown, planning device 205 may randomly add one or more IP links and/or optical links to output topology S23 (here, added IP links and/or optical links are indicated by solid lines in the middle graphic). As shown, planning device 205 may randomly remove multiple, different IP links and/or optical links from output topology S23 (here, removed IP links and/or optical links are indicated by dotted lines in the middle graphic). As shown, planning device 205 may generate the diversified network topology. As further shown, planning device 205 may assign a topology identifier to the diversified network topology (here, the topology identifier is S01′).

As shown by reference number 528, planning device 205 may determine a network topology cost associated with output topology S01′ (here, the network topology cost is 980). As shown, planning device 205 may perform a local search analysis on output topology S01′, to determine a second local minimum-cost network topology.

As shown by reference number 530, planning device 205 may generate an iteration of output topologies (here, the iteration is shown as iteration D), and may determine a network topology cost associated with each output topology. Based on the network topology cost, planning device 205 may select output topology S11′ as a current solution. As shown by reference number 532, planning device 205 may generate an iteration of output topologies based on output topology S11′ (here, the iteration is shown as iteration E). Planning device 205 may determine one or more network topology costs associated with the one or more network topologies of generation E. As shown, planning device 205 may determine that no output topology of iteration E is associated with a lower network topology cost than output topology S11′. As shown by reference number 534, planning device 205 may determine that S11′, associated with a network topology cost of 975, is a local minimum-cost network topology.

As shown in FIG. 5D, planning device 205 may perform a simulated annealing configuration technique to determine a reconfigured network topology. As shown by reference number 536, planning device 205 may associate a topology indicator with the initial network topology (here, the topology indicator is S01), and may determine a network topology cost associated with the initial network topology (here, the network topology cost is 1000). As shown by reference number 538, planning device 205 may determine a first acceptance threshold (here, the first acceptance threshold is P₁). Assume the first acceptance threshold of P₁ is associated with a particular probability. As further shown, planning device 205 may generate an iteration of output topologies, and may determine a network topology cost associated with each modified network topology (here, the iteration is shown as iteration F). Planning device 205 may select an output topology as a current solution based on the first acceptance threshold and the network topology cost associated with the output topology (here, planning device 205 selects modified network topology S13″ based on the first acceptance threshold, despite network topology S13″ being associated with a higher network topology cost than the initial network topology cost).

As shown by reference number 540, planning device 205 may determine a second acceptance threshold (here, P₂), and may generate an iteration of output topologies (here, the iteration is shown as iteration G). As further shown, planning device 205 may associate, with each output topology, a network topology cost and a topology identifier. As shown, planning device 205 may select output topology S23″ based on output topology S23″ being associated with a lower network topology cost than output topology S13″. As shown by reference number 542, planning device 205 may determine that output topology S23″ is an acceptable reconfigured network topology, based on the second acceptance threshold and the reconfiguration criterion, and using the simulated annealing reconfiguration technique.

As shown in FIG. 5E, and by reference number 544, planning device 205 may compare the reconfigured network topology, determined using the local search and search diversification reconfiguration techniques, and the reconfigured network topology determined using the simulated annealing reconfiguration technique. Assume that planning device 205 compares the reconfigured network topologies based on the reconfiguration criterion (here, the network topology cost associated with each reconfigured network topology). As shown, planning device 205 may select reconfigured network topology S23″, based on the reconfiguration criterion. As shown by reference number 546, planning device 205 may output information describing reconfigured network topology S23″, including the network topology cost associated with reconfigured network topology S23″. As further shown, a user associated with planning device 205 may use planning device 205 to request to view additional information related to reconfigured network topology S23″.

As shown in FIG. 5F, and by reference number 548, planning device 205 may display additional information related to reconfigured network topology S23″. As further shown, planning device 205 may display information related to a reconfigured IP network associated with reconfigured network topology S23″ (here, planning device 205 displays six IP link identifiers that identify six IP links, six IP link adjacency identifiers that identify one or more IP links that are adjacent to each particular IP link, and a data capacity associated with each IP link). As shown, planning device 205 may display information related to a reconfigured optical network associated with reconfigured network topology S23″ (here, planning device 205 displays five optical node identifiers that identify five optical nodes, and a number of wavelengths associated with each optical node). As shown by reference number 550, a user associated with planning device 205 may request that controller device 240 reconfigure the network associated with the initial network topology. Assume that the user uses planning device 205 to request that controller device 280 reconfigure IP network 215 and optical network 230.

As shown in FIG. 5G, and by reference number 552, controller device 240 may provide, to one or more edge IP nodes 220, one or more core IP nodes 225, and/or one or more optical nodes 235, reconfigured network topology information. As further shown, the one or more edge IP nodes 220, one or more core IP nodes 225, and/or one or more optical nodes 235 may reconfigure IP network 215, based on the reconfigured network topology information. In this way, controller device 240 may cause the one or more edge IP nodes 220, one or more core IP nodes 225, and/or one or more optical nodes 235 to reconfigure IP network 215, without requiring manual input by the user to reconfigure IP network 215.

As indicated above, FIGS. 5A-5G are provided merely as an example. Other examples are possible and may differ from what was described with regard to FIGS. 5A-5G.

In this way, a user (such as a network operator) may reconfigure the IP network topology and the optical network topology based on the initial network topology. The reconfigured IP network topology may be adapted to the optical network topology by design. In this way, the planning device may ensure that the network is efficiently designed to be resilient to failure in the IP network and/or the optical network, based on the combined cost of the IP network and the optical network.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more memories; and
one or more processors, connected to the one or more memories, to:
receive information that identifies an initial network topology, to be used to reconfigure a network,
the initial network topology describing an optical layer and an internet protocol layer of the network,
the internet protocol layer including an internet protocol node;
determine a reconfiguration criterion associated with the initial network topology,
the reconfiguration criterion describing a characteristic of the network, and
the reconfiguration criterion being used to reconfigure the network;
determine a reconfiguration technique to be used to reconfigure the network,
the reconfiguration technique including at least one of:
a local search reconfiguration technique,
a simulated annealing reconfiguration technique, or
a search diversification reconfiguration technique;
perform the reconfiguration technique;
generate a reconfigured network topology based on performing the reconfiguration technique,
the reconfigured network topology describing a reconfigured internet protocol layer and a reconfigured optical layer,
the reconfigured internet protocol layer being reconfigured based on the optical layer, and
the reconfigured network topology being reconfigured based on the initial network topology; and
provide the reconfigured network topology.

2. The device of claim 1, where the one or more processors, when receiving the information, are further to:
receive, from the internet protocol node, information associated with the initial network topology, to be used to reconfigure the network; and
where the one or more processors, when providing the reconfigured network topology, are further to:
provide, to the internet protocol node, the reconfigured network topology.

3. The device of claim 1, where the reconfiguration criterion includes network topology cost information,
the network topology cost information including one or more values describing a cost associated with the initial network topology.

4. The device of claim 1, where the one or more processors, when receiving the information that identifies the initial network topology, are further to:
receive a network protection attribute,
the network protection attribute defining a protection type,
the protection type including at least one of:
an unprotected protection type,
an IP network protection type, or
an IP network and optical network protection type; and
where the one or more processors, when generating the reconfigured network topology, are further to:
generate the reconfigured network topology based on the network protection attribute.

5. The device of claim 1, where the one or more processors, when performing the reconfiguration technique, are further to:
provide, to a server device and for performance of the reconfiguration technique, the initial network topology and the reconfiguration criterion; and
receive, from the service device, the reconfigured network topology,
the server device having performed the reconfiguration technique.

6. The device of claim 1, where the one or more processors, when receiving the information, are further to:
receive information that identifies a traffic priority identifier,
the traffic priority identifier identifying a network traffic flow, and
the traffic priority identifier identifying a traffic priority associated with the network traffic flow; and
where the one or more processors, when determining the reconfigured network topology, are further to:
determine the reconfigured network topology based on performing the reconfiguration technique,
the reconfigured network topology being determined based on the traffic priority.

7. The device of claim 1, where the one or more processors, when generating the reconfigured network topology, are further to:
generate the reconfigured network topology, based on at least one of:
a threshold value associated with the reconfiguration criterion,
a threshold time elapsed while performing the reconfiguration technique, or
a threshold quantity of iterations performed while performing the reconfiguration technique.

8. A computer-readable medium storing instructions, the instructions comprising:
one or more instructions that, when executed by one or more processors of a device, cause the one or more processors to:
receive information that identifies an initial network topology to be used to reconfigure a network,
the initial network topology including information associated with an internet protocol layer and an optical layer of the network,
the internet protocol layer including an internet protocol node, and
the optical layer including an optical node;
determine a reconfiguration criterion associated with the initial network topology,
the reconfiguration criterion describing a characteristic of the network;
determine a reconfiguration technique to be used to reconfigure the network,
the reconfiguration technique including at least one of:
a local search reconfiguration technique,
a simulated annealing reconfiguration technique, or
a search diversification reconfiguration technique;
perform the reconfiguration technique to obtain a plurality of reconfigured network topologies;
identify a reconfigured network topology of the plurality of reconfigured network topologies,
the reconfigured network topology describing a reconfigured internet protocol layer and a reconfigured optical layer,
the reconfigured internet protocol layer being reconfigured based on information associated with the optical layer; and
provide the reconfigured network topology.

9. The computer-readable medium of claim 8, where the one or more instructions, that cause the one or more processors to receive the information, further cause the one or more processors to:
receive, from the internet protocol node and the optical node, the information that identifies the initial network topology, to be used to reconfigure the network.

10. The computer-readable medium of claim 8, where the one or more instructions, that cause the one or more processors to determine the reconfiguration technique, further cause the one or more processors to:
determine the reconfiguration technique,
the reconfiguration technique including at least two of:
the local search reconfiguration technique,
the simulated annealing reconfiguration technique, or
the search diversification reconfiguration technique.

11. The computer-readable medium of claim 8, where the one or more instructions, that cause the one or more processors to provide the reconfigured network topology, further cause the one or more processors to:
provide, to the internet protocol node and the optical node, the reconfigured network topology.

12. The computer-readable medium of claim 8, where the one or more instructions, that cause the one or more processors to receive the information that identifies the initial network topology, further cause the one or more processors to:
receive a network protection attribute,
the network protection attribute defining a protection type,
the protection type including at least one of:
an unprotected protection type,
an IP network protection type, or
an IP network and optical network protection type; and
where the one or more instructions, that cause the one or more processors to identify the reconfigured network topology, further cause the one or more processors to:
identify the reconfigured network topology based on the network protection attribute.

13. The computer-readable medium of claim 8, where the one or more instructions, that cause the one or more processors to receive the information that identifies the initial network topology, further cause the one or more processors to:
receive information that identifies a traffic priority identifier,
the traffic priority identifier identifying a network traffic flow, and
the traffic priority identifier identifying a traffic priority associated with the network traffic flow; and
where the one or more instructions, that cause the one or more processors to generate the reconfigured network topology, further cause the one or more processors to:
generate the reconfigured network topology based on performing the reconfiguration technique,
the reconfigured network topology being reconfigured based on the traffic priority.

14. The computer-readable medium of claim 8, where the reconfiguration criterion includes a network topology cost,
the network topology cost being a value describing a cost associated with the initial network topology.

15. A method, comprising:
receiving, by a device, information that identifies an initial network topology to be used to reconfigure a network,
the initial network topology describing an internet protocol layer and an optical layer of the network,
the internet protocol layer including an internet protocol node, and
the optical layer including an optical node;
determining, by the device, an initial network topology cost associated with the network,
the initial network topology cost being a value describing a cost associated with the initial network topology;
determining, by the device, a reconfiguration technique, to be used to reconfigure the network,
the reconfiguration technique including at least one of:
a local search reconfiguration technique,
a simulated annealing reconfiguration technique, or
a search diversification reconfiguration technique;
performing, by the device, the reconfiguration technique;
determining, by the device, a reconfigured network topology based on performing the reconfiguration technique,
the reconfigured network topology describing a reconfigured internet protocol layer, and
the reconfigured network topology being determined based on the initial network topology cost; and
providing, by the device, the reconfigured network topology.

16. The method of claim 15, where determining the reconfiguration technique further comprises:
determining the reconfiguration technique, to be used to reconfigure the network,
the reconfiguration technique including at least two of:
the local search reconfiguration technique,
the simulated annealing reconfiguration technique, or
the search diversification reconfiguration technique.

17. The method of claim 15, where receiving the information that identifies the initial network topology further comprises:
receiving a network protection attribute,
the network protection attribute defining a protection type,
the protection type including at least one of:
an unprotected protection type,
an IP network protection type, or
an IP network and optical network protection type; and
where determining the reconfigured network topology further comprises:
determining the reconfigured network topology based on the network protection attribute.

18. The method of claim 15, where providing the reconfigured network topology further comprises:
providing, to the internet protocol node and the optical node, the reconfigured network topology; and
causing the internet protocol node and the optical node to reconfigure the internet protocol layer based on the reconfigured network topology.

19. The method of claim 15, where determining the reconfiguration technique further comprises:
selecting at least two of:
the local search reconfiguration technique,
the simulated annealing reconfiguration technique, or
the search diversification reconfiguration technique.

20. The method of claim 15, where receiving the information further comprises:
receiving information that identifies a service protection attribute,
the service protection attribute identifying a network service, and
the service protection attribute identifying a service priority associated with the network service; and
where determining the reconfigured network topology further comprises:
determining the reconfigured network topology based on performing the reconfiguration technique,
the reconfigured network topology being determined based on the service priority.
